(19) United States
(12) Patent Application Publication
(10) Pub. No.: US 2014/0043183 A1
(43) Pub. Date: Feb. 13, 2014

(54) ACOUSTIC HETERODYNE RADAR

(71) Applicants: Larry G. Stolarczyk, Raton, NM (US); Gerald Stolarczyk, Raton, NM (US); Igor Bausov, Raton, NM (US); Laxni Narayana Botla, Raton, NM (US); Joseph Duncan, Raton, NM (US); Richard B. Main, Newark, CA (US)

(72) Inventors: Larry G. Stolarczyk, Raton, NM (US); Gerald Stolarczyk, Raton, NM (US); Igor Bausov, Raton, NM (US); Laxni Narayana Botla, Raton, NM (US); Joseph Duncan, Raton, NM (US); Richard B. Main, Newark, CA (US)

(21) Appl. No.: 13/570,257

(22) Filed: Aug. 9, 2012

(51) Int. Cl. G01S 13/06

(52) U.S. Cl. 342/22

(57) ABSTRACT

Acoustic heterodyne radars use accurately surveyed or otherwise known locations to repetitively launch at least two, intense acoustic tone soundwaves (F1, F2) into an underground area of search. An acoustic receiver is tuned to receive either the sum (F1+F2) or difference (|F1−F2|) heterodynes and is configured to measure and log the overall relative attenuation and roundtrip travel times of the soundwaves, like a typical radar. Any acoustic heterodynes received are assumed to be the work of non-linearities and stresses in the search area. A full-waveform three dimensional tomography algorithm is applied by a graphics processor to the collected and logged data to generate maps and profiles of objects beneath the ground which are interpreted to have produced the acoustic heterodynes.

### BACKGROUND

1. Field of the Invention

The present invention relates to radar devices and methods, and more particularly to imaging underground tunnels and bores by using the stress fields that typically surround their peripheries to mix and radiate heterodynes of intense acoustic tones injected from nearby vantage points.

2. Description of the Prior Art

Remote sensing into the earth to find, characterize, and image deeply buried objects and features has always been difficult. Ground penetrating radars have been developed that depend on measuring the delays, attenuations, and phase shifts imposed on reflections of radiowaves to characterize and image what lies beneath. Companies like Stolar, Inc. (Raton, N. Mex.) have gotten quite good at sorting out the carrier frequencies, modulation schemes, synchronous detection techniques, and antenna construction needed to look deep into the earth to find coal deposits, mining hazards, trapped miners, and even smugglers' tunnels.

Heterodyning is generally a radio signal processing technique in which new frequencies, specifically the sum and difference frequencies (F1+F2, |F1−F2|), are generated by combining two frequencies (F1, F2) in a mixer. EH Armstrong used this phenomenon to great effect when he developed the first heterodyne receivers.

The principal characteristic of mixers and why they can mix is that they are non-linear. Linear circuits will not produce heterodynes. The most common non-linear electronic devices are vacuum tubes, transistors, and diodes.

It just so happens that acoustic waves traveling through solid media will heterodyne when two or more intense tones are passed through non-linear materials. Loads and stress in rock and other natural deposits will produce non-linearities able to support acoustic heterodyning. Tunnels and boreholes in the earth are naturally surrounded by stress fields in the supporting, surrounding media and the stresses tend to concentrate at corners or arches.

The determination of the initial stress patterns in rock masses is an important problem in engineering rock mechanics. It is also an important basis for the stability analysis of the rock surrounding underground openings, high rock slopes, arch dam shoulders, dam foundations, and the study of reservoir induced earthquakes. Ma Qichao, Department of Hydraulic Engineering, Tianjin University, published a paper on the subject titled, “The Cause of Formation of the Initial Stress Field in Engineering Rock masses and the Rule of Stress Distribution in the Field”, Chinese Journal of Rock Mechanics and Engineering, 1986-04.

Researchers have generally identified that stress fields inherently surround even well bores and rectangular tunnels. See, Investigation Study of the Stress Field Surrounding a Well Bore and a Rectangular Tunnel, by Biao Qiu and Yi Luo of the Department of Mining Engineering, West Virginia University, published as Stress Fields around Underground Openings, 2011. More often than not, the conventional concerns about the stress fields surrounding boreholes and tunnels is the stresses can cause breakouts, fragment spalling, and other failures.

Acoustic waves can travel long distances and to great depths in the earth. This then makes the use of acoustic waves to scan deeply buried objects very attractive, maybe more so than using radiowaves.

### SUMMARY OF THE INVENTION

Briefly, acoustic heterodyne radar embodiments of the present invention use accurately surveyed or otherwise known locations to repetitively launch at least two, intense acoustic tone soundwaves (F1, F2) into an underground area of search. An acoustic receiver is tuned to receive either the sum (F1+F2) or difference (|F1−F2|) heterodynes and is configured to measure and log the overall relative attenuation and roundtrip travel times of the soundwaves, like a typical radar. Any acoustic heterodynes received are assumed to be the work of non-linearities and stresses in the search area. A full-waveform three dimensional tomography algorithm is applied by a graphics processor to the collected and logged data to generate maps and profiles of objects beneath the ground which are interpreted to have produced the acoustic heterodynes.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a cross section diagram of an underground area representing the data collection procedure for an acoustic heterodyne radar embodiment of the present invention;

FIG. 2 is a functional block diagram of a computed tomography (CT) radar imaging system embodiment of the present invention that can use the equipment of FIG. 1 for analysis and collection of data;

FIG. 3 is a diagram showing the blinding that can occur if the near field return and signal clutter is not suppressed;

FIG. 4 is a cross section diagram of an underground area representing a situation in which an underground area 402 targeted for mining needs to be stabilized;

FIG. 5 is a graph of a double sideband suppressed carrier waveform;

FIG. 6 is a phasor representation of the gradiometric heterodyne process and quadrature detection of the far zone reflected I and Q Signals; and

FIG. 7 is a graph of the so-called Bausov Suppression Factor depended upon by embodiments of the present invention and more fully described in U.S. Pat. No. 7,656,342.

### DETAILED DESCRIPTION OF THE PREFERRED EMBODIMENT

Tunnels and boreholes driven into natural media create non-linear stress fields surrounding the void. The logarithmic pressure field distribution in a one-dimensional radial distance from a circular locus of points with radius (R_{c}) and pressure (P_{c}) to a concentric well bore with effective radius (r_{b}) and face pressure (P_{b}) can be represented by,

$$P ( r ) - {P}_{c} = \frac{{P}_{b} - {P}_{c}}{1 n ( \frac{{R}_{c}}{{r}_{b}} )} In ( \frac{{R}_{c}}{r} ) .$$

The natural logarithm (ln) power series expansion is mathematically given by,

$$Ln ( 1 + x ) = x - \frac{{x}^{2}}{2} + \frac{{x}^{3}}{3} - \frac{{x}^{4}}{4} + \frac{{x}^{5}}{5} … .$$

A narrow band near the borehole experiences most of the pressure differential. For example, R_{c}≈100 m, and r_{b}≈0.1 m, more than one-third of the pressure differential occurs across the 1 meter nearest to the borehole core. More than one-half of the pressure differential occurs across a zone with a radius of R_{c}≈3 m. The situation is even more pronounced for boreholes with smaller radii, r_{b}.

In general, the stress field can be represented by a Taylor series expansion. When two or more sinusoidal seismic S (i.e., slow traverse) waves, seismic P (i.e., fast longitudinal) waves, or acoustic frequency signals travel along a refraction path crossing through a non-linear stress field, the heterodyne of the two signals generates at least a sum and difference frequency signal given by

\hat{f}=nf₁±mf₂.

When the stress field is strongly follows a square law, the best product frequencies \hat{f} are predominately the sum (upper heterodyne) and the difference (lower heterodyne) frequency. The magnitudes of the generated signals depend on the coefficient of the power series expansion.

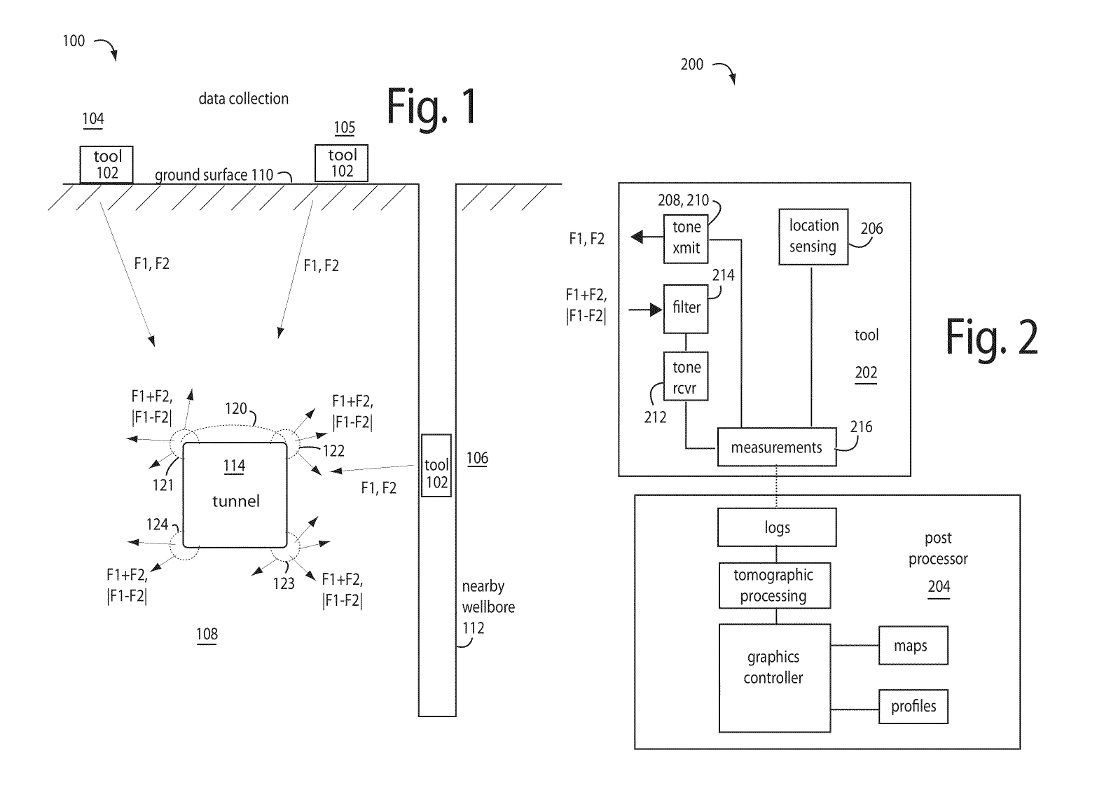

FIG. 1 represents the data collection procedure 100 for an acoustic heterodyne radar embodiment of the present invention. A tool 102, represented at multiple locations 104-106, includes a pair of acoustic radiators configured to launch simultaneous pairs of intense audio tones (F1, F2) into an underground area of search 108. Tool 102 is variously located on the ground surface 110 or a nearby wellbore 112, serially at what can easily be a hundred different vantage points.

The object is to locate any deeply buried boreholes and/or tunnels 114. The pressures cause by the overburden will naturally cause stresses to develop in the solid materials immediately surrounding the boreholes and tunnels 114. Such overburden or lithostatic pressure imposes stresses proportional to the weight of overlying materials, for example:

p(z)=p₀+g∫₀^{z}ρ(z)dz

where, ρ(z) is the density of the overlying rock at depth z and g is the acceleration due to gravity, p₀ is the datum pressure, like the pressure at the surface. The depths involved here are a very small fraction of the Earth's radius, so “g” is placed outside of the integral for most near-surface applications.

Stresses which cause non-linearities surrounding boreholes and/or tunnels 114 are represented in FIG. 1 by stress-fields 120-124. Stress-fields 120-124 will mix and produce sum (F1+F2) and difference (|F1−F2|) heterodynes when intense audio tones (F1, F2) reach each of them respectively. Their corresponding times of travel and relative attenuation as seen by a receiver can be used to reveal the likely locations of the stress-fields 120-124 that produced them. Embodiments of the present invention interpret clusters of such heterodynes as having come from objects similar to boreholes and tunnels 114. Historical data from weeks, months, and even years before can be used to confirm or highlight recent changes that are probably manmade.

Tools 102 include an acoustic receiver able to filter through the heterodynes and measure their relative times of arrival and attenuation. These measurements are collected in real-time for use in post processing.

FIG. 2 represents a computed tomography (CT) radar imaging system 200 that includes at least one data collection tool 202 for in-field use and a post processor 204 for later data analysis and interpretation. The data collection tool 202 includes a surveying mechanism 206 for determining and logging the three dimensional locations of each of the pair of acoustic radiators 208, 210, and the location of acoustic receiver 212. The locations are logged during particular launches of pairs of intense audio tones, and the concomitant reception of sum (F1+F2) or difference (|F1−F2|) heterodynes. A filter 214 is used to bandpass selected heterodynes. Data collection tool 202 is similar to tool 102 (FIG. 1).

A measurements device 216 is included to determine the travel times and attenuation of any said heterodynes returned from said underground area of search to the acoustic receiver based on when and where audio tones F1, F2 were launched and where the acoustic receiver was then located.

A log 218 is configured to collect and store data in real time produced by the measurement device 216, and to carry such to post processing. A computed tomography (CT) processor 220 uses an algorithm to translate the data in log 218 into three dimensional images. A graphics controller 222 presents these to users in the form of maps 224 and profiles 226 of any tunnels and/or boreholes (e.g., 114) that may be situated in the underground area of search (e.g., 108).

Most of the acoustic heterodynes arriving and being measured at the receiver 212 are assumed to be the work of non-linearities and stresses in the underground area of search that naturally surround and outline tunnels and/or boreholes. Other anomalies and computational idiosyncrasies will produce image artifacts that will need to be ignored or scrubbed.

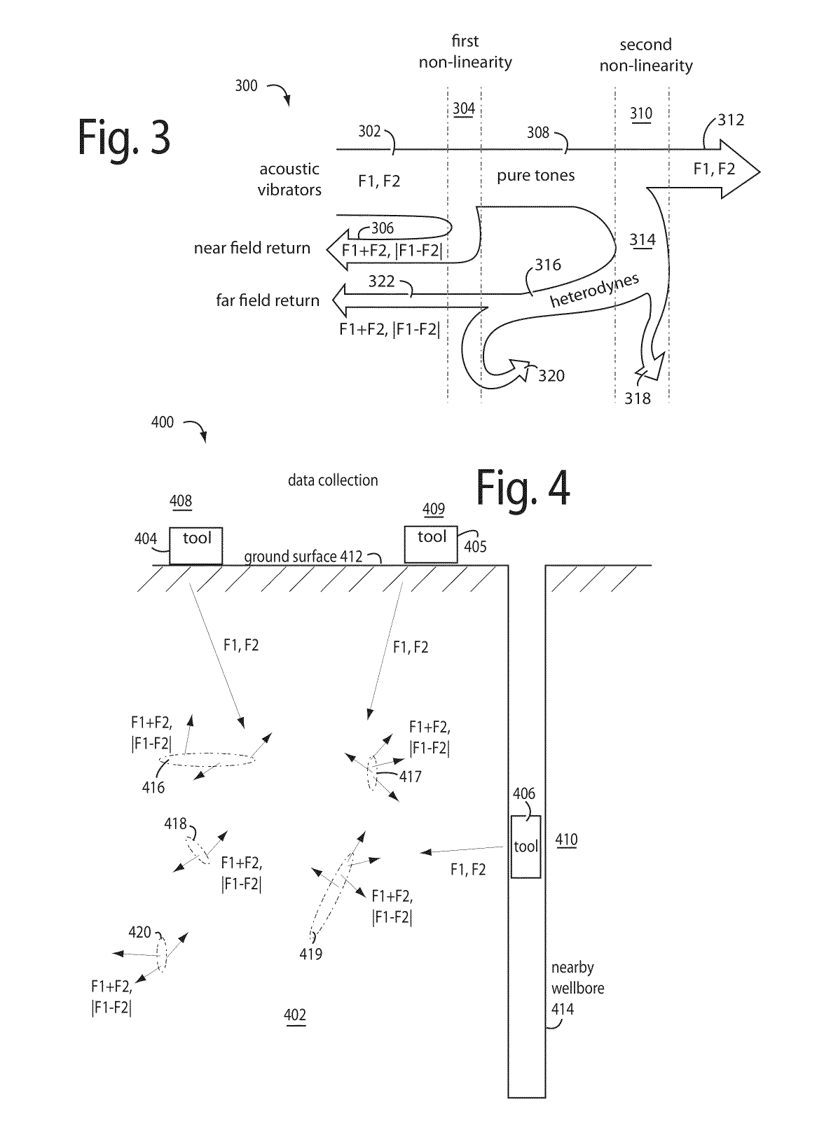

Receiver geophones can be built with magnetic wire coils surrounding a permanent magnetic. The coil is mounted to an Earth contact plate. The mounting configuration can be on three orthogonal axes. The media movement along each axis generates an electromotive force (EMF) voltage measured by instruments. The transmitter may be a piezoelectric ceramic radiator driven by a series of short time domain pulses that are synchronized to a direct digital synthesizer and controllable in frequency steps from 3-kHz to 30-kHz, which receives the spectra components including the transmitted frequencies ω₁ and ω₂ and the non-linear stress field heterodyne frequencies. Each of the frequency components may be a unique spectrum for each individual source. The received heterodyne signals can be re-heterodyned in electronic circuits to create a common intermediate frequency enabled by a detection process described in FIG. 3-22. The path range can be determined by varying the modulation frequency.

Clutter caused by near field generation of heterodynes at the first interface can be suppressed by adapting the Bausov method described in U.S. Pat. No. 7,656,342, issued Feb. 2, 2010, and titled, DOUBLE-SIDEBAND SUPPRESSED-CARRIER RADAR TO NULL NEAR-FIELD REFLECTIONS FROM A FIRST INTERFACE BETWEEN MEDIA LAYERS. Instead of using pairs of radio frequency continuous wave (CW) transmissions, pairs of acoustic tones are substituted.

The near field return of blinding signal clutter is represented in FIG. 3. An acoustic transmission 302 comprising two tones, F1 and F2, is launched from an air environment into a solid media. The solid media will have a stress field at this first interface causing a first non-linearity 304. Tones F1 and F2 will mix and produce near field heterodyne return 306. A remainder 308 of the energy of the original F1 and F2 tones will proceed on to a second interface of the solid media with the void of a tunnel or borehole causing a second non-linearity 310. A remainder 312 of the energy of the original F1 and F2 tones will proceed on. But a portion 314 that is in proportion to the magnitude and severity of second non-linearity 310 will be returned as heterodynes 316. Some will simply dissipate as losses 318. More losses 320 will occur at the first non-linearity 304. A relatively weak and diminished far field heterodyne return 322 will get back. The near field heterodyne return 306 can be so strong and the far field heterodyne return 322 so faint, that detecting and using the information can be impossible or quite challenging. Embodiments of the present invention therefore use the Bausov method described in U.S. Pat. No. 7,656,342, to suppress the near field heterodyne return 306.

Using non-linear stress fields 120-124 to find and identify an otherwise unknown tunnel 114 has been described above. But when tunnel 114 is already known, and it is the extent and severity of the non-linear stress fields 120-124 that are unknown, then tool 102, tool 202, and post processor 204 can be usefully employed. Conventional methods of characterizing and measuring the stresses surrounding boreholes and tunnels have not employed acoustic heterodynes.

FIG. 4 represents a situation 400 in which an underground area 402 targeted for mining needs to be stabilized. Coal and other deposits can be rifled with cracks, fissures, and paleo-channels that can make mining through them very dangerous. The techniques and equipment described in FIG. 1 can be usefully adapted to locate, characterize, and map the more serious of these faults. Tools 404-406 are moved to positions 408-410 on a ground surface 412 or a wellbore 414. Acoustic waves are transmitted, received, their signals analyzed, data logged, and information accumulated.

Each fault is assumed to be enveloped in a stress field 416-420 that manifests as a non-linearity able to mix acoustic tones and radiate heterodynes. Stress-fields 416-420 will mix and produce sum (F1+F2) and difference (|F1−F2|) heterodynes when intense audio tones (F1, F2) reach each of them respectively. Their corresponding times of travel and relative attenuation as seen by a receiver can be used to reveal the likely locations of the stress-fields 416-420 that produced them. Embodiments of the present invention interpret such heterodynes as having come from underground cracks, fissures, and unconsolidated sediments or semi-consolidated sedimentary rocks deposited in ancient, long-inactive river and stream channels, e.g., paleo-channels.

Tools 404-406 include at least one acoustic receiver amongst them able to filter through the heterodynes and measure the relative times of arrival and attenuation. These measurements are collected in real-time for use in post processing, e.g., as in FIG. 2.

The information obtained is used in mining operations that follow later to avoid the faults or to drill ahead to stabilize the ground with injections of epoxies, cements, or other fillers and/or to install bolts and other devices. For example, TAM International Australia PTY Ltd (South Australia) markets several ground stabilization products including acrylic injection grout, colloidal silica, injection cement, and polyurethane grout for fissure grouting and injection ahead of tunnel boring machines (TBM).

The Bausov method described in U.S. Pat. No. 7,656,342 describes how deep-look ground penetrating radar gradiometers (DLRG) can overcome the problem traditional ground penetrating radars have by being blinded by overly bright near zone signals, crosstalk coupling, first interface reflections, and other clutter. Deep-look ground penetrating radar gradiometers can reject 60-dB of such clutter by transmitting double sideband (DSB) suppressed carrier frequency components to achieve greater detection depth by gradiometric suppression of arriving near zone signals.

See FIG. 5, DLRG detection is made possible by transmitting double sideband suppressed carriers, either acoustic or radio frequency. Two fixed frequencies can be considered to represent the upper and lower sidebands of a suppressed center frequency. The DLRG transmit and receive radian frequency (ω=2πf) signals applied to the mixer are phase coherent with heterodyne signals. The gradiometric functionality is achieved by down converting each of the arriving lower and upper sideband signals to an ensemble of signals each down converted to the same intermediate frequency. The modulation frequency (ωm) is,

$$\dot{θ} = \frac{1}{S / N} ,$$

in radians per second.

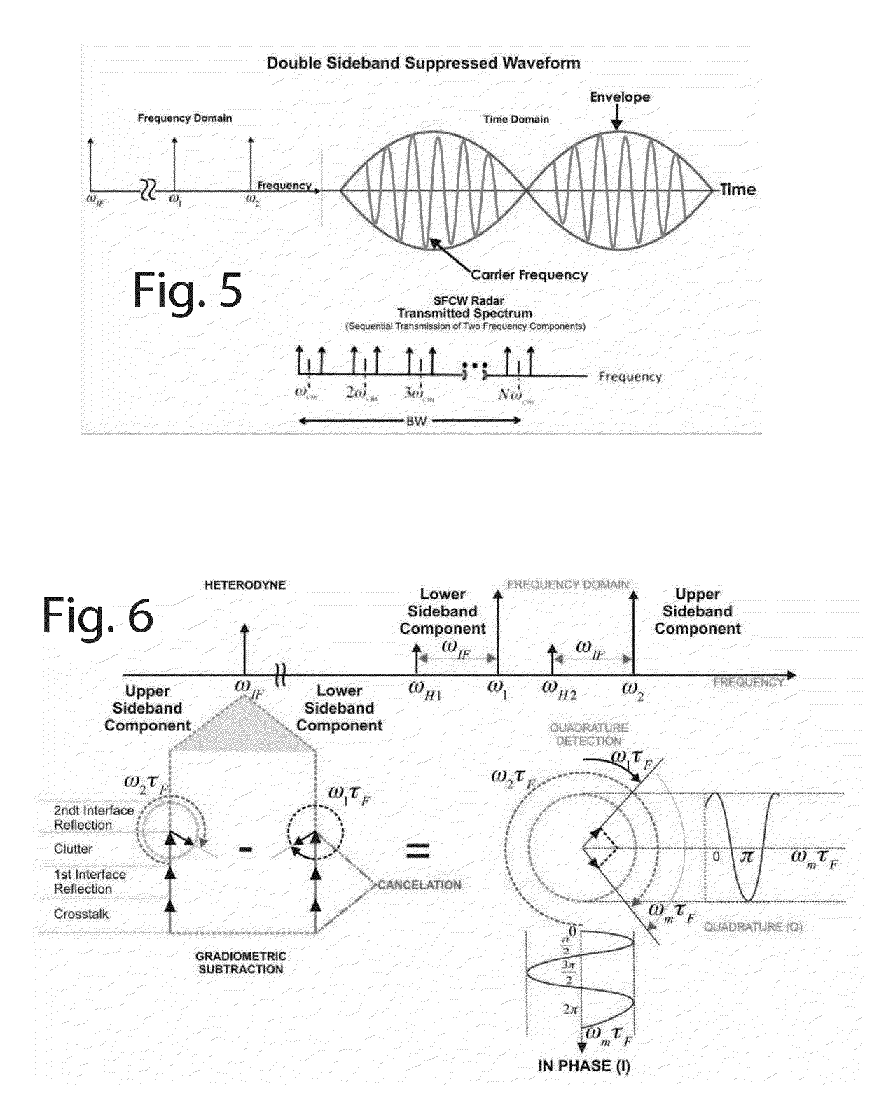

The ensemble of lower sideband frequency components is represented by the vector sum of phasors, each with nearly identical phase shift (i.e., ω1τN). The ensemble of upper sideband frequency components is represented by the vector sum of phasors each with nearly identical phase shift (ω2τN). The ensemble of lower sideband signals is subtracted from the upper sideband signal in the heterodyne down conversion (i.e., mixer) process. The subtraction occurs because the heterodyne process causes the lower and upper ensemble of signals to be 180° out of phase with each other. The lower and upper sideband signals reflected from the far zone interface are each shifted in phase by the radian frequency of each component multiplied by the round-trip travel times (i.e., ω₁τ_{F} and ω₂τ_{F}). FIG. 6 represents a phasor representation of the gradiometric heterodyne process and quadrature detection of the far zone reflected I and Q Signals. (U.S. Pat. No. 6,522,285 B2).

The reflection signals arriving from the second interface are also represented as a phasor and add to the vector sum of the lower and upper sideband phasors but with a phase difference (ωmτF) that is varied by a controller, as represented by the dashed circles at the end of each summation of phasors in FIG. 6. The gradiometric subtraction of the second interface phasors is carried out by the microprocessor varying the phase of the upper and lower heterodyne frequency components with an optimization algorithm that minimizes, or nulls, the magnitudes of the ensemble of intermediate frequency signals.

Measurements show that near zone cross talk, first interface, and clutter signals are suppressed by at least 60 dB, an improvement of 30-dB over non-double sideband processing methods. An ensemble of intermediate frequency signals is applied to a quadrature detector. The in-phase (I) and quadrature (Q) components of the intermediate frequency signal are recovered and algorithmically processed to display detection and range to an object. The quadrature detector in-phase (I) and quadrature (Q) signals are mathematically represented by,

I=cos(ωₘτ+θₘ)cos(ω_{cm}τ+θ_{cm}),

and,

Q=cos(ωₘτ+θₘ)sin(ω_{cm}τ+θ_{cm}),

where, ω_{cm}=2πf_{cm} is the radian frequency of the suppressed carrier signal and f_{cm} is in Hertz.
The magnitude of quadrature detection signal,

M=|I²+Q²|^{1/2}=|cos(θₘ+ωₘτ)|

and phase of the suppressed carrier is given by,

$${ω}_{cm} τ + {θ}_{cm} = {tan}^{- 1} \frac{Q}{⊥} .$$

A controller manipulates the sideband separation frequency (ωm) to determine the range or distance to the object. Since the round trip travel time to the second reflecting interface is invariant, the change in modulation frequency (Δω) required for the I,Q signals to vary from maximum to minimum determines the range is,

$$R = \frac{1}{2} υ {τ}_{F} = \frac{π υ}{4 Δ {ω}_{m}}$$

where, the velocity, v, in the natural media is, for example, approximately 1.5×10⁸ meters/second through coal.

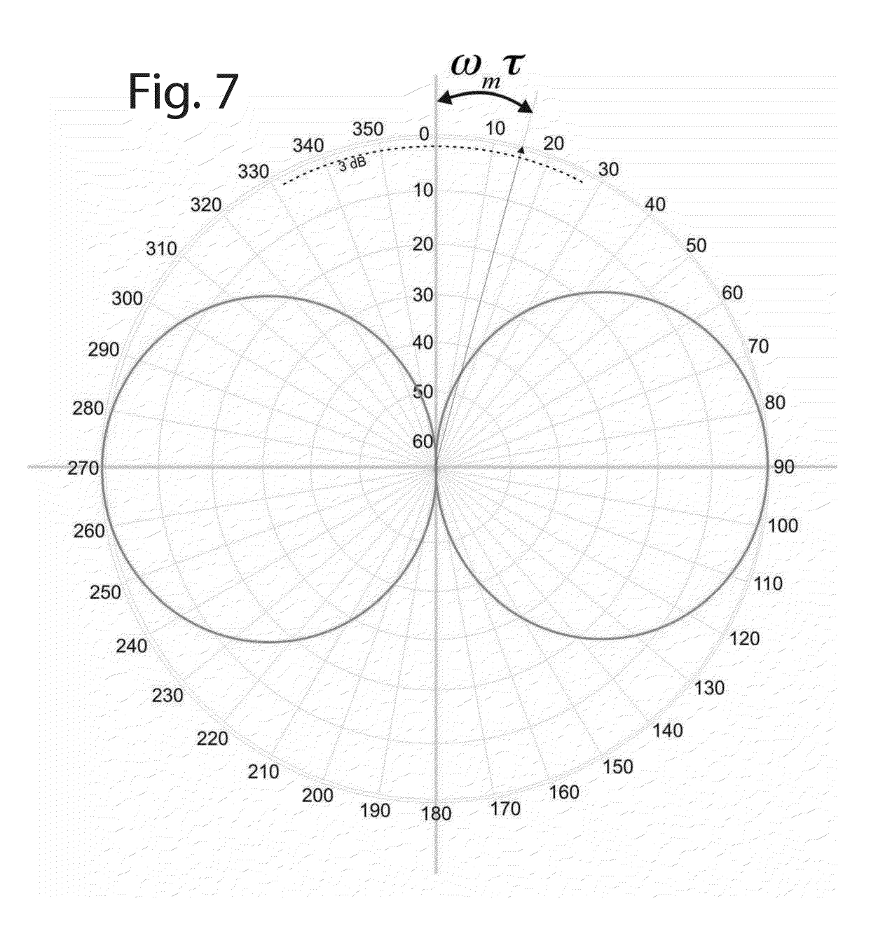

Each heterodyne double sideband signal coherent phase difference is shifted in phase (θm) to π/2 radians, which changes the magnitude coefficients of the I, Q signals from cos(ωmτ) to the sin(ωmτ). As the Bausov suppression chart of FIG. 7 illustrates, near zone (small i) signals are suppressed by the sin(ωmτ).

FIG. 7 is a graph of the Bausov Suppression Factor. The two lobes represent the near zone suppression dependence on modulation frequency (ωm). The transmitted spectrum, F(ω), of each source can be detected and auto correlation processing of the media heterodyne signals is used to detect the non-linear stress fields of voids.

Each pair of received frequency components are heterodyned (down-difference or up-sum converted) to the same intermediate frequencies (IF) in superheterodyne type receiver. Each frequency component can be represented by a phasor vector whose length represents the magnitude of received frequency component. Each phasor is phase shifted 180° from the other in the heterodyne process and gradiometrically subtracted to minimize the magnitude of the IF signal. The attenuation rate and phase shift (loss tangent greater than unity) depends on the first power of frequency. The magnitude and phase shift of each received frequency component will be different.

The phase of the heterodyning signal can be used to minimize the magnitude of the IF signal input to the analog to digital converter (ADC). The full range of the ADC is needed to digitize the variations in electrical conductivity and their effects on attenuation and phase as measured by the phase coherent quadrature detection process.

Gradiometer subtraction of IF phasors is used to suppress the magnitude of the IF signal and enables automatic gain control and full dynamic rage digitization of the frequency dependent attenuation and phase shift.

The processed data enables full waveform 3D tomography reconstruction of geologic anomalies even where refraction occurs along transmission paths. A significant problem in imaging mineralized zones and anomalies in the coal seam waveguide is refraction distortion can create artifacts in the image reconstructions.

Acoustic heterodyne equipment and methods could also be usefully employed in cutterhead drums of continuous mining machines used in underground coal mining. Acoustic imaging radar promises to be able to map the fractures and cleats in the coal beds and faces ahead of the mining to help improve machine design, bit lacing patterns, performance and campaign life.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. An acoustic heterodyne radar, comprising:
a pair of acoustic radiators each configured to launch respective ones of simultaneous pairs of pure audio tones (F1, F2) into an underground area of search;
an acoustic receiver tuned to receive either the sum (F1+F2) or difference (|F1−F2|) heterodynes from said underground area of search, and to reject audio tones F1 and F2;
a surveying mechanism for determining and logging the three dimensional locations of each of the pair of acoustic radiators and acoustic receiver during particular launches of said pairs of pure audio tones and any reception of said sum (F1+F2) or difference (|F1−F2|) heterodynes;
a measurement device for determining the travel time and attenuation of any said sum (F1+F2) or difference (|F1−F2|) heterodynes generated within and returned from non-linear parts of said underground area of search to the acoustic receiver based on when and where said pure audio tones were launched and where the acoustic receiver was then located; and
a logger configured to collect, record, and store data produced by the measurement device in real time and to reproduce such later for post processing;
wherein, said sum (F1+F2) or difference (|F1−F2|) heterodynes measured are assumed to have been mixed from non-linearities and stresses in said underground area of search.

2. The acoustic heterodyne radar of claim 1, further comprising:
a computed tomography processor connected and configured to translate said data in the logger into maps and profiles of any tunnels and/or boreholes that may be situated in said underground area of search;
wherein, the estimated locations of said tunnels and/or boreholes constitute an information output of the radar.

3. The acoustic heterodyne radar of claim 1, further comprising:
a computed tomography processor connected and configured to translate said data in the logger into maps and profiles of tunnels and/or boreholes situated in said underground area of search;
wherein, the extent and intensity of the stresses estimated to be surrounding said tunnels and/or boreholes constitute an information output of the radar.

4. The acoustic heterodyne radar of claim 1, further comprising:
a computed tomography processor connected and configured to translate said data in the logger into maps and profiles of any cracks, fissures, and/or paleo-channels that may be situated in said underground area of search;
wherein, estimates of the locations of said cracks, fissures, and/or paleo-channels constitute an information output of the radar.

5. The acoustic heterodyne radar of claim 4, wherein:
an injected ground stabilization grout or cement positioned in the earth according to the principal information output of the radar.

6. The acoustic heterodyne radar of claim 1, further comprising:
a Bausov mechanism configured to suppress any near field heterodyne signals wherein sensitivity is improved for any far field heterodyne signals.

7. A method for acoustic heterodyne radar, comprising:
launching simultaneous pairs of pure audio tones (F1, F2) into an underground area of search respectively with a pair of acoustic radiators;
limiting any receiving to the sum (F1+F2) and/or difference (|F1−F2|) acoustic heterodynes from said underground area of search with an acoustic receiver tuned to detect and measure only them;
determining and logging the three dimensional locations of each of the pair of acoustic radiators and acoustic receiver during particular launches of said pairs of pure audio tones and any reception of said sum (F1+F2) or difference (|F1−F2|) heterodynes with a surveying mechanism;
determining the travel time and attenuation with a measurement device of any said heterodynes returned from said underground area of search to the acoustic receiver based on when and where said pure audio tones were launched and where the acoustic receiver was then located;
collecting and storing data produced by the measurement device in real time and producing such later for post processing; and
assuming at least some of the acoustic heterodynes measured are the work of non-linearities and stresses in said underground area of search;
wherein, refraction distortions are reduced that would otherwise create artifacts in any image reconstructions.

8. The method of claim 7, further comprising:
applying computed tomography to the data in post processing to identify and estimate the locations of any previously unknown boreholes and/or tunnels in said underground area of search.

9. The method of claim 7, further comprising:
applying computed tomography to the data in post processing to identify and estimate the locations of any cracks, fissures, and/or paleo-channels in said underground area of search.

10. The method of claim 7, further comprising:
applying computed full waveform 3D tomography to the data in post processing to identify and estimate the extent and intensity of any stresses surrounding already known boreholes and/or tunnels in said underground area of search.

11. A remote sensing ground penetrating radar for estimating distances to non-linear media caused by stresses in the media, comprising:
a transmitter configured to launch two pure tone signals (F1 and F2) into the earth;
a receiver sensitive only to the sum or difference heterodynes (|F1−F2| or F1+F2) from the earth;
a timing device for measuring the apparent time delay (t1−t2) incurred from the time (t1) said two pure tone signals (F1 and F2) were launched by the transmitter to the time (t2) said sum or difference heterodynes (|F1−F2| or F1+F2) were detected by the receiver; and
a device to estimate, from measurements of said time delay (t1−t2), a radar range distance to an unknown non-linearity that may have caused a mixing of said two pure tone signals (F1 and F2) into said sum or difference heterodynes (|F1−F2| or F1+F2);
wherein such estimates are useful to find, characterize, and image deeply buried objects and features that are surrounded by stress fields that produce non-linearities.
